(19) United States
(12) Patent Application Publication
(10) Pub. No.: US 2006/0115300 A1
(43) Pub. Date: Jun. 1, 2006

(54) Waste developer dealing device of image forming apparatus and dealing method

(75) Inventors: Jun-Hee Lee, Suwon-si (KR); Jong-Cheon Hong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/272,082

(22) Filed: Nov. 14, 2005

(30) Foreign Application Priority Data
Nov. 29, 2004 (KR) 2004-98458

(51) Int. Cl. G03G 15/10

(52) U.S. Cl. 399/237

(57) ABSTRACT

A waste developer dealing device and a method of dealing with the waste developer is provided. The waste developer dealing device includes a developing unit forming an image using a developer supplied, a withdrawing container arranged below the developing unit to store the waste developer removed from the developing unit, and a developer discharging passageway connected to the withdrawing container. The developing unit receives a mixture of the waste developer and water and a water supplying unit supplies water to the developing unit.

### CROSS-REFERENCE TO RELATED APPLICATIONS

This application claims the benefit under 35 U.S.C. § 119(a) of Korean Patent Application No. 2004-98458, filed Nov. 29, 2004, the entire disclosure of which is hereby incorporated by reference.

### BACKGROUND OF THE INVENTION

1. Field of the Invention

The present invention relates to an image forming apparatus. More particularly, the present invention relates to a waste developer dealing device which withdraws and discharges waste developer that remains on a wet-type image forming apparatus using a liquid developer and a dealing method for the apparatus.

2. Description of the Related Art

In general, in a wet-type image forming apparatus using a liquid developer, ink is supplied to a developing unit so as to form a visible image on a photosensitive drum on which an electrostatic latent image is formed. The visible image is transferred to a transfer unit such as a transfer belt or a transfer roller. Then, the visible image is transferred to a printing sheet. As a result, a complete image is printed on the printing sheet.

Ink that remains after being transferred to a photosensitive medium or a transfer medium is generally removed by a cleaning blade and stored in a waste developer container via a predetermined discharging duct. The ink is then separately discharged by a user. In cases where a (solid) density of a waste developer is less than about 3%, the flow of waste developer discharged through a discharging duct is generally relatively good. However, in a wet-type image forming apparatus using a high density liquid developer, the density of a substantial portion of waste developer discharged is frequently more than about 3%. In cases where the waste developer has a density of more than about 3%, the waste developer accumumlates inside the developing unit and the discharging duct and often clogs the components due to an increase in developing speed and the large number of media printed.

As printing is performed at high speeds and on a large number of printing sheets, clogging of the discharging duct is frequent. Thus, the flow of the waste developer becomes relatively poor. As a result, waste developer is not discharged from the developing unit to the outside. Accordingly, the waste developer accumulates in the developing unit. Also, the image forming apparatus may be damaged by the contamination of waste developer. As a result, the lifespan of the image forming apparatus is shortened. In addition, in cases where the discharging duct for the waste developer clogs, the user must directly clean sludge accumulated in the discharging duct. Moreover, the developer unit requires continuous cleaning, repair, and maintainenance of the discharging duct to prevent the discharging duct from clogging.

Accordingly, there is a need for an improved image forming apparatus including a waste developer dealing device which increases flow of waste developer and prevents clogging of a discharging duct and a method of dealing with waste developer.

### SUMMARY OF THE INVENTION

An aspect of the present invention is to address at least the above problems and/or disadvantages and to provide at least the advantages described below. Accordingly, an aspect of the present invention is to provide a waste developer dealing device of an image forming apparatus for increasing flow of waste developer so as to relatively smoothly pass the waste developer through a discharging duct and a method of dealing with the waster developer.

Another aspect of the present general inventive concept is to provide a waste developer dealing device of an image forming apparatus that can be relatively easily repaired and maintained.

Still another aspect of the present general inventive concept is to provide a waste developer dealing device of an image forming apparatus which reduces costs for repairing and maintaining the device.

According to an aspect of the present invention, there is provided a waste developer dealing device of an image forming apparatus including a developing unit which forms an image using a developer. A withdrawing container is arranged under the developing unit which stores the waste developer removed from the developing unit. A developer discharging passageway is connected to the withdrawing container and the developing unit passes a mixture of the waste developer and water. Additionally, a water supplying unit supplies water to the developing unit.

The water supplying unit may also include a water supplying passageway connecting the developing unit to the withdrawing container and a water supplying pump supplying the water stored in the withdrawing container to the developing unit through the water supplying passageway.

The water supplying passageway may be formed of a substantially hollow pipe, for example, formed of a flexible rubber material.

The water supplying passageway may include an absorbing end connected to a lower portion of the withdrawing container and a discharging end connected to the developing unit. Thus, naturally separated water located under the waste developer may be only supplied to the developing unit.

The water supplying pump may be provided, for example, a metering pump which controls an amount of water supplied.

The discharging end of the water supplying passageway is arranged adjacent to a waste developer plate of the developing unit.

According to another aspect of the present invention, there is provided a method of dealing with waste developer of an image forming apparatus. The method includes the steps of removing waste developer remaining on a developing unit of the image forming apparatus, supplying water to the removed waste developer, moving a mixture of the waste developer and the water through a discharging passageway, and storing the mixture in a withdrawing container.

The water is supplied to the removed waste developer and may include pumping the water stored in the withdrawing container via a water supplying pump. Additionally, discharging the water to the developing unit so that the water is mixed with the waste developer.

The method may further include naturally dividing the mixture stored in the withdrawing container into the water and the waste developer.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a front view of a waste developer dealing device according to an embodiment of the present invention;

FIG. 2 is a side view of the waste developer dealing device shown in FIG. 1;

FIG. 3 is a side view of a developing unit shown in FIG. 1;

FIG. 4 is a view of a portion of the interior of the developing unit shown in FIG. 1;

FIG. 5 is a cross-sectional view of the interior of a withdrawing container shown in FIG. 1;

FIG. 6 is a flowchart of a method of dealing with the waste developer according to an embodiment of the present invention; and

FIG. 7 is a flowchart of a process of supplying water in the method shown in FIG. 6.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, a waste developer dealing device and a method of dealing with the waste developer according to the exemplary embodiments of the present invention will be described in detail with reference to the attached drawings.

A waste developer dealing device may be used in any device using a developer. For example, the waste developer dealing device may be used in a wet-type image forming apparatus which electrically forms an electrostatic image, forms an image on a photosensitive drum using a developer, and transfers the image to a printing sheet. Thus, in the present embodiment, a waste developer dealing device will be described which adopts a wet-type laser beam printer forming an image using a liquid developer, the wet-type laser beam printer being a kind of wet-type image forming apparatus.

The wet-type laser beam printer includes a paper cassette (not shown) to store sheets of paper, a paper feeding unit (not shown) to feed sheets of paper, a developing unit 20 to develop a toner image on a sheet of paper, and a fixing unit (not shown) which fixes the developed image onto the sheet of paper. Such elements are known elements of a printer, and thus a detailed description of the functions and constructions thereof will be omitted for clarity and conciseness. Hereinafter, the waste developer dealing device of embodiments of the present invention will be described.

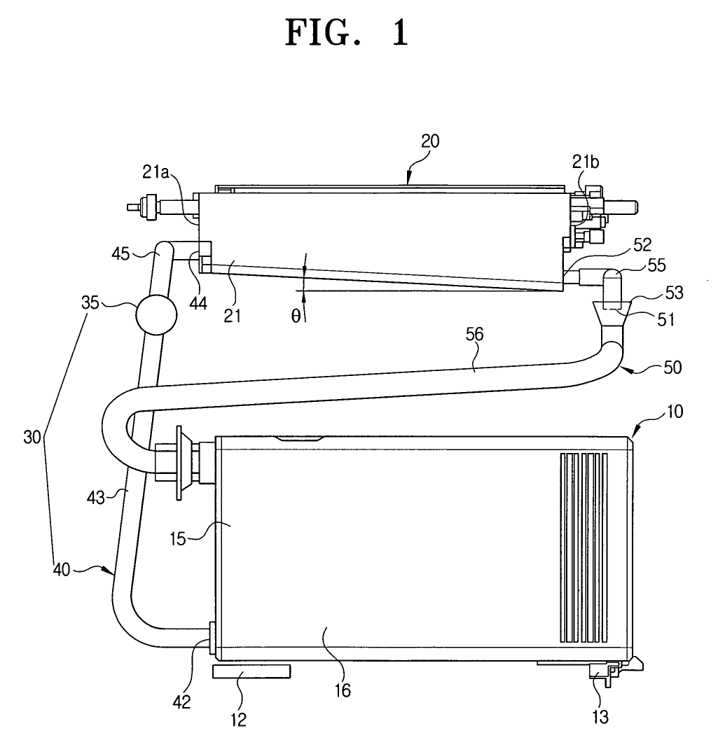

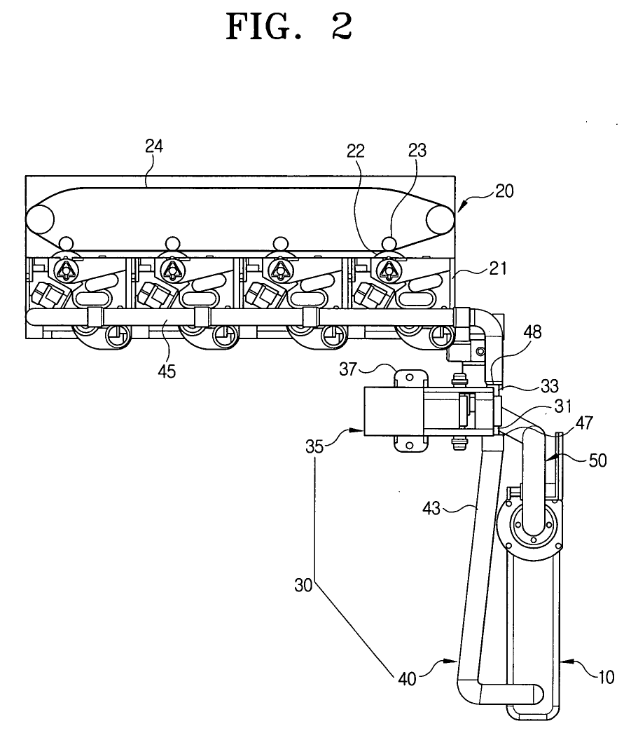

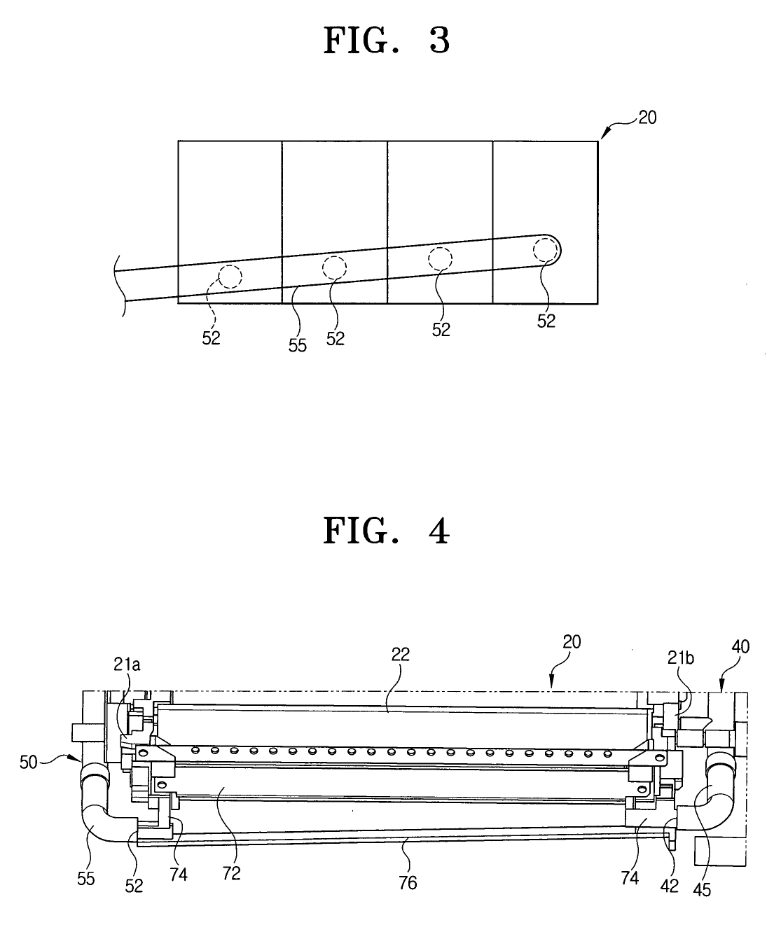

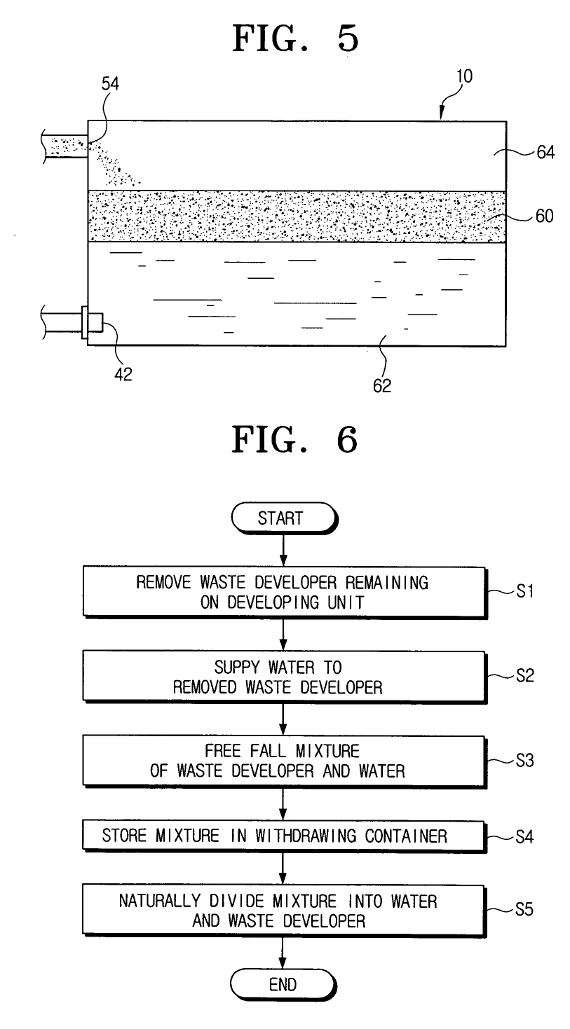

FIG. 1 is a front view of a waste developer dealing device according to an embodiment of the present invention, FIG. 2 is a side view of the waste developer dealing device shown in FIG. 1, FIG. 3 is a side view of a developing unit shown in FIG. 1, FIG. 4 is a view of a portion of the interior of the developing unit shown in FIG. 1, and FIG. 5 is a cross-sectional view of the interior of a withdrawing container shown in FIG. 1.

Referring to FIG. 1, the waste developer dealing device according to the present embodiment includes a developing unit 20, a withdrawing container 10, a developer discharging passageway 50 through which a waste developer is discharged from the developing unit 20 to a withdrawing container 10, and a water supplying unit 30 supplying water from the withdrawing container 10 to the developing unit 20.

Referring to FIGS. 1 and 2, the developing unit 20 includes photosensitive drums 22, support rollers 23, and a transfer belt 24. The photosensitive drums 22 may be any suitable photosensitive media such as a photosensitive belts, and the transfer belt 24 may be any suitable transfer media such as a transfer drum. The four photosensitive drums 22 are rotatably arranged on a frame 21 of the developing unit 20 to respectively correspond to four colors. The transfer belt 24 is arranged on the four photosensitive drums 22 so as to receive developers from the photosensitive drums 22. To remove waste developer remaining on surfaces of the photosensitive drums 22 after the developers are transferred to the transfer belt 24, cleaning parts 72 are installed on sides of the photosensitive drums 22 to contact the photosensitive drums 22 as shown in FIG. 4. Sludge plates 76 are also installed on sides of the cleaning parts 72 to gather the removed waste developer.

Referring to FIGS. 1 and 2, a discharging end 44 of the water supplying passageway 40 is connected to a side 21a of the frame 21 of the developing unit 20 so as to supply water to the sludge plates 76 inside the developing unit 20. An absorbing end 52 of the developer discharging passageway 50 is connected to another end 21b of the frame 21 so as to discharge the waste developer. Also, referring to FIG. 1, the frame 21 of the developing unit 20 slants at a predetermined angle θ from the discharging end 44 of the water supplying passageway 40 toward the absorbing end 52 of the developer discharging passageway 50 through which the waste developers are discharged. Here, the frame 21 slants so that supplied water cleanses the developer inside the developing unit 20 and flows into the developer discharging passageway 50.

The withdrawing container 10 stores the waste developer discharged from the developing unit 20. The withdrawing container 10 is arranged below the developing unit so that the waste developers and mixtures of the waste developers and water drop due to gravity. As shown in FIGS. 1 and 2, the withdrawing container 10 is rectangular but may have various shapes depending on the size of the image forming apparatus. As shown in FIG. 5, the discharging end 54 of the developer discharging passageway 50 is connected to an upper portion of the withdrawing container 10 so that the mixtures of the water and the waste developers drop into an inner upper portion 15. Also, the absorbing end 42 of the water supplying passageway 40 is connected to a lower portion 16 of the withdrawing container 10 so as to supply water stored at an inner bottom of the withdrawing container 10 to the developing unit 20. A supporter 12 supporting the withdrawing container 10 and a bracket 13 fixing a position of the withdrawing container 10 are shown in FIG. 1.

Referring to FIG. 1, the developer discharging passageway 50 includes first and second hollow pipes 55 and 56. The first hollow pipe 55 includes the absorbing end 52 into which the mixtures of the waste developer and the water flow. Additionally, a first connection end 51 is inserted into a second connection end 53 of the second hollow pipe 56 so as to transfer the mixtures to the second hollow pipe 56. The second hollow pipe 56 includes the second connection end 53 which is funnel-shaped so as to enclose the first connection end 51 of the first hollow pipe 55 and the discharging end 54 is connected to the withdrawing container 10. In the present embodiment, the first and second hollow pipes 55 and 56 are made of a rubber material. The rubber material is suitable to constitute a passageway that is flexible and carries the waste developers. However, the first and second hollow pipes 55 and 56 may be ducts made of various other suitable materials and can have various shapes. The absorbing end 52 of the first hollow pipe 55 is connected to the other end 21b of the frame 21 of the developing unit 20, and the discharging end 54 of the second hollow pipe 56 is connected to the upper portion 15 of the withdrawing 10 container. The absorbing end 52 and the discharging end 54 of the first and second hollow pipes 55 and 56 are attached to and/or detached from the frame 21 of the developing unit 20 and the withdrawing container 10. Here, the first and second hollow pipes 55 and 56 are attached to and/or detached from the frame 21 of the developing unit 20 and the withdrawing container 10 by fasteners such as driving screws. Alternatively, the first and second hollow pipes 55 and 56 may be attached to and/or detached from the frame 21 of the developing unit 20 and the withdrawing container 10 using known various techniques including a conventional one-touch method.

Referring to FIG. 2, the water supplying unit 30 includes the water supplying passageway 40 and a water supplying pump 35. The water supplying passageway 40 includes a third hollow pipe 43 connected to the withdrawing container 10 and a fourth hollow pipe 45 connected to the developing unit 20. The third and fourth hollow pipes 43 and 45 are also preferably made of a rubber material. An absorbing end 42 of the third hollow pipe 43 is connected to the withdrawing container 10 as shown in FIG. 1, and a third connection end 47 is connected to a motor inlet 31. A fourth connection end 48 of the fourth hollow pipe 45 is connected to a motor outlet 33, and the discharging end 44 is connected to the developing unit 20.

The water supplying pump 35 is installed between the third and fourth hollow pipes 43 and 45 so as to supply water to the developing unit 20. The water supplying pump 35 may be a known metering pump so as to appropriately adjust an amount of water supplied. However, the water supplying pump 35 may be any other suitable pump. As shown in FIG. 2, the water supplying pump 35 is fixed to the frame (not shown) of the image forming apparatus using a bracket 37.

FIG. 3 is a side view of the developing unit 20 connected to the first hollow pipe 55 shown in FIG. 1. As shown in FIG. 3, the first hollow pipe 55 is installed at an angle with respect to the developing unit 20. In other words, as shown in FIG. 1, the first hollow pipe 55 slants from the absorbing end 52 of the first hollow pipe 55 toward the first connection end 51 so that the mixtures of the waste developers and the water flow through the first hollow pipe 55 due to gravity.

FIG. 4 is a view of a portion of the interior of the developing unit 20 shown in FIG. 1. The cleaning blades 72 are installed at the sides of the photosensitive drums 22, and the sludge plates 76 are installed so as to gather the waste developers flowing beside the cleaning blades 72. The sludge plates 76 are slanted toward the first hollow pipe 55 so that the waste developers are gathered at the sludge plates 76 and naturally flow. Barrier ribs 74 are installed at the end 21a of the developing unit 20, for example, in close proximity to a side of the discharging end 44 of the fourth hollow pipe 45, and the other end 21b of the developing unit 20, for example, in close proximity to a side of the absorbing end 52 of the first hollow pipe 55, so as to prevent water sprayed from the fourth hollow pipe 45 from splashing toward the photosensitive drums 22 and to discharge the mixture of the waste developer and the water to the first hollow pipe 55.

A waste developer dealing device and a method of dealing a waste developer according to the embodiments of the present invention will now be described with reference to the attached drawings.

Referring to FIG. 6, in operation S1, the waste developer remaining on the photosensitive drums 22 or the transfer belt 24 are removed by the cleaning blades 72. In the present embodiment, the waste developer removed from the photosensitive drums 22 flow along surfaces of the cleaning blades 72 to the sludge plates 76.

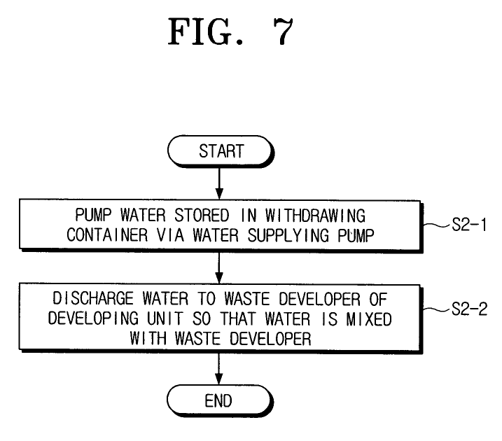

In operation S2, water is supplied toward the sludge plates 76 of the developing unit 20. Referring to FIG. 7, operation S2 is divided into operations S2-1 and S2-2. In operation S2-1, the water supplying pump 35 pumps water gravitating toward the bottom of the withdrawing container 10. In operation S2-2, the water moves along the third and fourth hollow pipes 43 and 45, and is discharged to the developing unit 20, cleanses the waste developer gathered on the sludge plates 76, and mixes with the waste developer. Here, the mixture of the waste developer and the water moves to the side of the developing unit 20.

In operation S3, the waste developer gravitates along the first and second hollow pipes 55 and 56 using water as a transport medium. The mixture of the water and the waste developer has a lower density and viscosity than the waste developer. Therefore, the mixture smoothly flows down the first and second hollow pipes 55 and 56 without clogging the first and the second hollow pipes 55 and 56. The mixture gravitates from the absorbing end 54 of the first hollow pipe 55 and is discharged to the first connection end 51 of the first hollow pipe 55. Then, the mixture flows into the second connection end 53 of the second hollow pipe 56 and is discharged to the discharging end 54 of the second hollow pipe 56. As described above, water cleanses the developing unit, and dilutes and transports the density of the waste developer. Thus, efforts to clean the developing unit and a discharging passageway can be reduced. As a result, repair and maintenance are reduced.

In operation S4, the waste developer and water are stored in the withdrawing container 10.

In operation S5, the waste developer is naturally separated from the water in the withdrawing container 10 after a predetermined period of time. The weight of the water is for example, “1,” and the weight of the waste developer is smaller than “1.” Thus, the water gravitates toward the bottom while the waste developer remains on top of the water. As shown in FIG. 5, the water 62 and waste developer 60 separate from each other due to differences between their specific gravities. An empty space 64 is shown in FIG. 5 inside the withdrawing container 10.

The embodiments of the present invention have been described instancing a waste developer dealing device adapted for an image forming apparatus, in particular, a wet-type laser beam image forming apparatus.

While the invention has been shown and described with reference to certain embodiments thereof, it will be understood by those skilled in the art that various changes in form and details may be made therein without departing from the spirit and scope of the invention as defined by the appended claims.

What is claimed is:

1. A waste developer dealing device of an image forming apparatus, comprising:
a developing unit forming an image using a developer;
a withdrawing container arranged below the developing unit to store waste developer removed from the developing unit;
a developer discharging passageway connected to the withdrawing container and the developing unit which passes a mixture of the waste developer and water; and
a water supplying unit supplying water to the developing unit.

2. The waste developer dealing device of claim 1, wherein the water supplying unit comprises:
a water supplying passageway connecting the developing unit to the withdrawing container; and
a water supplying pump supplying the water stored in the withdrawing container to the developing unit through the water supplying passageway.

3. The waste developer dealing device of claim 2, wherein the water supplying passageway is a substantially hollow pipe.

4. The waste developer dealing device of claim 3, wherein the hollow pipe is formed of a rubber material.

5. The waste developer dealing device of claim 2, wherein the water supplying passageway comprises:
an absorbing end connected to a lower portion of the withdrawing container; and
a discharging end connected to the developing unit.

6. The waste developer dealing device of claim 5, wherein the water supplying pump is a metering pump controlling an amount of water supplied.

7. The waster developer dealing device of claim 5, wherein the discharging end of the water supplying passageway is located adjacent to a waste developer plate of the developing unit.

8. The waste developer dealing device of claim 1, wherein the developer discharging passageway is a substantially hollow pipe and comprises a discharging end connected to an upper portion of the withdrawing container.

9. A method of dealing a waste developer of an image forming apparatus, comprising the steps of:
removing a waste developer remaining on a developing unit of the image forming apparatus;
supplying water to the removed waste developer;
moving a mixture of the waste developer and the water through a discharging passageway; and
storing the mixture in a withdrawing container.

10. The method of claim 9, wherein supplying the water to the removed waste developer comprises:
pumping the water stored in the withdrawing container via a water supplying pump; and
discharging the water to the waste developer of the developing unit so that the water is mixed with the waste developer.

11. The method of claim 10, further comprising:
naturally dividing the mixture stored in the withdrawing container into the water and the waste developer.
